(19) United States
(12) Patent Application Publication
(10) Pub. No.: US 2016/0187850 A1
(43) Pub. Date: Jun. 30, 2016

(54) DATA FORMAT FOR HOLOGRAM, AND APPARATUS AND METHOD FOR HOLOGRAPHIC VIDEO SYSTEM

(71) Applicant: Electronics and Telecommunications Research Institute, Daejeon (KR)

(72) Inventor: Kwan Jung OH, Daejeon (KR)

(21) Appl. No.: 14/674,932

(22) Filed: Mar. 31, 2015

(30) Foreign Application Priority Data
Dec. 31, 2014 (KR) 10-2014-0195470

(51) Int. Cl. G03H 1/08; H04N 19/136; G03H 1/22; H04N 19/124

(52) U.S. Cl. CPC G03H 1/08; H04N 19/124; H04N 19/136; G03H 1/2294

(57) ABSTRACT

A holographic image processing method and a holographic image display method are provided. The holographic image processing method performed by a holographic image processing apparatus may include acquiring a holographic image, encoding the holographic image by quantizing the holographic image to improve at least one of a temporal correlation, a spatial correlation, and a channel correlation of the acquired holographic image, and generating the encoded holographic image.

### CROSS-REFERENCE TO RELATED APPLICATION

This application claims the priority benefit of Korean Patent Application No. 10-2014-0195470, filed on Dec. 31, 2014, in the Korean Intellectual Property Office, the disclosure of which is incorporated herein by reference.

### BACKGROUND

1. Field of the Invention

Embodiments of the present invention relate to a method and an apparatus for processing and displaying a holographic image, and a computer-readable recording medium.

2. Description of the Related Art

Holography is a technique using refraction and interference of light. While only the amplitude of light is recorded for a conventional two-dimensional (2D) image, holography uses not only the amplitude but also the phase of light to provide a vivid three-dimensional (3D) image as if an object is actually present before the user eyes. Holography receives attention as an ultimate 3D imaging technique.

Accordingly, studies on diverse holographic video systems to provide holographic image services are actively being conducted. Generally, various studies on an apparatus and method of acquiring and generating holographic data, codec technology of compression-transmitting and decoding holographic data, and a holographic display apparatus capable of reproducing holographic data are carried out.

Holographic data is mostly acquired directly or created by computer-generated holography (CGH). Also, holographic data is displayed as an amplitude hologram or phase hologram using a spatial light modulator (SLM) used for a display apparatus. The amplitude hologram or phase hologram is displayed as a general image form.

Currently, there is no standardized holographic data format, which causes difficulty in developing techniques of compressing, processing and displaying holographic data for holographic image services in the future.

A hologram is hard to compress in high efficiency due to characteristics of a holographic image different from those of existing 2D/3D images.

### SUMMARY

An aspect of the present invention is to solve the aforementioned problems.

Another aspect of the present invention is also to provide a holographic video system which defines a holographic data format for high-efficiency compression and effective hologram services and is based on the holographic data format.

Still another aspect of the present invention is to provide a high-quality holographic image with a smaller number of bits through a unified hologram format and efficient compression.

The present invention is constructed as follows to achieve the aforementioned objects of the present invention and to realize characteristic effects of the present invention to be mentioned below.

According to an aspect, there is provided a holographic image processing method performed by a holographic image processing apparatus, the method including acquiring a holographic image, encoding the holographic image by quantizing the holographic image to improve at least one of a temporal correlation, a spatial correlation, and a channel correlation of the acquired holographic image, and generating the encoded holographic image.

The encoding of the holographic image may encode the holographic image by quantizing the holographic image using a ratio based on absolute values of maximum values or minimum values of a real part and an imaginary part of a complex number field of the acquired holographic image.

The encoding of the holographic image may encode the holographic image by deriving a ratio based on absolute values of maximum values or minimum values of a real part and an imaginary part of a complex number field using a texture image and a depth image among the acquired holographic images and quantizing the holographic image. The texture image may have a fixed pixel value, and the depth image may have a random pixel value.

The encoding of the holographic image may encode the holographic image by generating a random pattern for successive holographic images among the acquired holographic images, and may encode the holographic image by using the same random pattern as the random pattern or a modified random pattern generated by modifying the same random pattern for adjacent areas of the holographic images.

The encoding of the holographic image may encode the holographic image by modifying a pixel pitch of an area with a different wavelength among the acquired holographic images, or may encode the holographic image by modifying a wavelength of an area with a different pixel pitch among the acquired holographic images.

The holographic image processing method may further include receiving wavelength information and pixel pitch information of a holographic image display apparatus configured to display the encoded holographic image from the holographic image display apparatus. The encoding of the holographic image may encode the holographic image based on the received wavelength information and pixel pitch information.

According to another aspect, there is provided a holographic image display method performed by a holographic image display apparatus, the method including receiving a holographic image encoded by a holographic image processing apparatus, outputting the holographic image by decoding the received encoded holographic image, and displaying the output holographic image, wherein the encoded holographic image is generated by quantizing a holographic image to improve at least one of a temporal correlation, a spatial correlation, and a channel correlation.

The holographic image display method may further include receiving metadata including wavelength information and pixel pitch information of the encoded holographic image, and transcoding the output decoded holographic image when the wavelength information and the pixel pitch information of the encoded holographic image are different from a wavelength and a pixel pitch supported by the holographic image display apparatus. The displaying of the holographic image may include displaying the transcoded holographic image.

The encoded holographic image may include a holographic image encoded by quantizing a holographic image acquired by the holographic image processing apparatus using a ratio based on absolute values of maximum values or minimum values of a real part and an imaginary part of a complex number field of the acquired holographic image.

According to another aspect, there is provided a holographic image processing apparatus including a holographic image acquirer to acquire a holographic image, a holographic image encoder to encode the holographic image by quantizing the holographic image to improve at least one of a temporal correlation, a spatial correlation, and a channel correlation of the acquired holographic image, and a holographic image generator to generate the encoded holographic image.

The holographic image encoder may quantize the holographic image using a ratio based on absolute values of maximum values or minimum values of a real part and an imaginary part of a complex number field of the acquired holographic image.

The holographic image encoder may quantize the holographic image by deriving a ratio based on absolute values of maximum values or minimum values of a real part and an imaginary part of a complex number field using a texture image and a depth image among the acquired holographic images. The texture image may have a fixed pixel value, and the depth image may have a random pixel value.

The holographic image encoder may encode the holographic image by generating a random pattern for successive holographic images among the acquired holographic images, and may encode the holographic image by using the same random pattern as the random pattern or a modified random pattern generated by modifying the same random pattern for adjacent areas of the holographic images.

The holographic image encoder may encode the holographic image by modifying a pixel pitch of an area with a different wavelength among the acquired holographic images.

The holographic image processing apparatus may further include a display apparatus transceiver to transmit the generated holographic image to a holographic image display apparatus configured to display a holographic image.

The display apparatus transceiver may receive wavelength information and pixel pitch information of the holographic image display apparatus from the holographic image display apparatus. The holographic image encoder may encode the holographic image based on the received wavelength information and pixel pitch information.

According to another aspect, there is provided a holographic image display apparatus including a holographic image receiver to receive a holographic image encoded by a holographic image processing apparatus, a holographic image outputter to output the holographic image by decoding the received encoded holographic image, and a holographic image display to display the output holographic image, wherein the encoded holographic image is generated by quantizing a holographic image to improve at least one of a temporal correlation, a spatial correlation, and a channel correlation.

The holographic image receiver may receive metadata including wavelength information and pixel pitch information of the encoded holographic image. The holographic image display apparatus may further include a holographic image transcoder to transcode the output decoded holographic image when the wavelength information and the pixel pitch information of the encoded holographic image are different from a wavelength and a pixel pitch supported by the holographic image display apparatus. The holographic image display may display the transcoded holographic image.

The encoded holographic image may include a holographic image encoded by quantizing a holographic image acquired by the holographic image processing apparatus using a ratio based on absolute values of maximum values or minimum values of a real part and an imaginary part of a complex number field of the acquired holographic image.

According to another aspect, there is provided a computer-readable recording medium that is a holographic image recording medium including a holographic image encoded by a holographic image processing apparatus, and metadata including wavelength information and pixel pitch information of the encoded holographic image, wherein the encoded holographic image is generated by quantizing a holographic image acquired by the holographic image processing apparatus in order to improve at least one of a temporal correlation, a spatial correlation, and a channel correlation.

According to another aspect, there is provided a computer-readable recording medium that is a holographic image recording medium including holographic data formatted by at least one of a format expressing a real part and an imaginary part together, a format defining a real part only, and a format having only phase information obtained through a real part and an imaginary part as a holographic data format applicable to a technique of improving temporal, spatial and channel correlations.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an entire system of a holographic image processing apparatus and a holographic image display apparatus according an embodiment;

FIG. 2 is a flowchart illustrating a holographic image processing method performed by a holographic image processing apparatus according to an embodiment;

FIG. 3 is a flowchart illustrating a holographic image processing method according to an embodiment;

FIG. 4 is a flowchart illustrating a holographic image display method performed by a holographic image display apparatus according to an embodiment;

FIG. 5 illustrates a holographic image processing method and a holographic image display method according to an embodiment;

FIG. 6 is a block diagram illustrating a holographic image processing apparatus according to an embodiment;

FIG. 7 is a block diagram illustrating a holographic image display apparatus according to an embodiment; and

FIG. 8 is a block diagram illustrating a holographic image recording medium as a computer-readable recording medium according to an embodiment.

### DETAILED DESCRIPTION

Hereinafter, exemplary embodiments of the present invention will be described in detail with reference to the accompanying drawings.

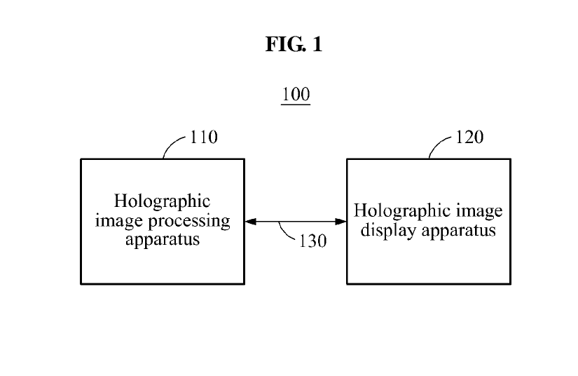

FIG. 1 is a diagram illustrating an entire system of a holographic image processing apparatus and a holographic image display apparatus according an embodiment.

Referring to FIG. 1, the entire system includes the holographic image processing apparatus 110 and the holographic image display apparatus 120.

According to the embodiment, the holographic image processing apparatus 110 may encode an acquired holographic image and transmit 130 the encoded holographic image to the holographic image display apparatus 120. The holographic image display apparatus 120 may decode the encoded holographic image transmitted from the holographic image processing apparatus 110 and display the holographic image.

Further, in the embodiment, the holographic image display apparatus 120 may transmit information for displaying the holographic image to the holographic image processing apparatus 110 in operation 130. The holographic image processing apparatus 110 may encode the holographic image by referring to the information for displaying the holographic image.

Although a holographic data format is expressed by both a real part and an imaginary part of a complex number field in the embodiment, a holographic data format may be defined by a real part only or include only phase information obtained through a real part and an imaginary part. In this case, the following techniques may also be applied to improve temporal, spatial and channel correlations.

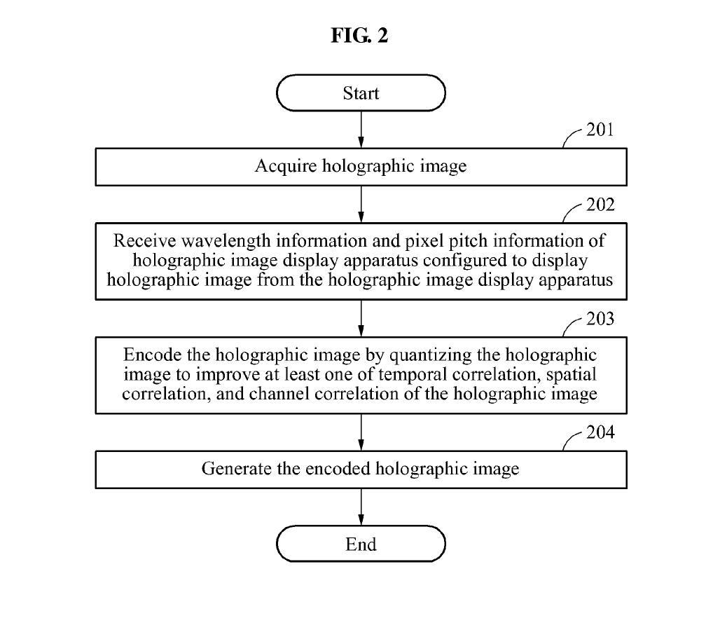

FIG. 2 is a flowchart illustrating a holographic image processing method performed by a holographic image processing apparatus according to an embodiment.

Referring to FIG. 2, the holographic image processing method performed by the holographic image processing apparatus is carried out as follows.

In operation 201, the holographic image processing apparatus may acquire a holographic image. In some cases, the holographic image processing apparatus may acquire holographic data.

In operation 202, the holographic image processing apparatus may receive wavelength information and pixel pitch information of a holographic image display apparatus configured to display a holographic image from the holographic image display apparatus. When the holographic image processing apparatus does not receive the wavelength information and pixel pitch information of the holographic image display apparatus from the holographic image display apparatus, a defined pixel and pixel pitch may be used. In operation 202, the holographic image processing apparatus does not always receive the wavelength information and pixel pitch information from the holographic image display apparatus. For example, when a wavelength and a pixel pitch are standardized, the holographic image processing apparatus may not receive the wavelength information and the pixel pitch information from the holographic image display apparatus.

In operation 203, the holographic image processing apparatus may quantize the acquired holographic image to improve at least one of a temporal correlation, a spatial correlation, and a channel correlation of the holographic image, thereby encoding the acquired holographic image. Alternatively, the holographic image processing apparatus may also quantize the acquired holographic data to improve at least one of a temporal correlation, a spatial correlation, and a channel correlation of the holographic data, thereby encoding the holographic image. Here, the holographic image processing apparatus may quantize the holographic image using a ratio based on absolute values of maximum values or minimum values of a real part and an imaginary part of a complex number field of the acquired holographic image, thereby encoding the holographic image.

In the embodiment, the holographic image processing apparatus may derive a ratio based on absolute values of maximum values or minimum values of a real part and an imaginary part of a complex number field using a texture image and a depth image among the acquired holographic images to quantize the holographic image, thereby encoding the holographic image. Alternatively, the holographic image processing apparatus may also derive a ratio based on absolute values of maximum values or minimum values of a real part and an imaginary part of a complex number field using a texture image and a depth image among holographic images acquired as the holographic data to quantize the holographic image, thereby encoding the holographic image. Here, the texture image has a fixed pixel value and the depth image has a random pixel value.

For instance, the holographic image processing apparatus derives a complex number field using a texture image having a pixel value of 255 and a depth image having a random pixel value and derives a minimum value and a maximum value of the complex number field, for which a value of a complex number field may become larger with a greater pixel value of a texture image and change depending on overlapping of depth images. Also, since combinations of depths which result in a minimum value and a maximum value in a widest range change depending on a wavelength and pixel pitch, the holographic image processing apparatus uses a random depth image. Accordingly, the holographic image processing apparatus may utilize a random depth image even for generating less-complexity and real-time holograms and be capable of processing nay input image as long as a wavelength and pixel are fixed. In addition, as necessary, the holographic image processing apparatus may derive and use a minimum value and a maximum value of a complex number field for an entire area of a holographic video.

In the embodiment, for successive holographic images among the acquired holographic images, the holographic image processing apparatus may generate a random pattern to encode the holographic images. Here, the holographic image processing apparatus may encode the holographic images by using the same random pattern or a modified random pattern generated by modifying the same random pattern for adjacent areas of the holographic images.

For instance, the holographic image processing apparatus, for an adjacent area small enough not to deteriorate in hologram quality, may use the same random value or modify a single random pattern into another random pattern to be applied to a row or column in an expanded manner. Also, the holographic image processing apparatus may form a plurality of random patterns and optimize the patterns in view of spatial correlation. Using the patterns, the holographic image processing apparatus may generate a random phase pattern having a high spatial correlation and randomness. When the holographic image processing apparatus isolates a process of providing a random phase effect to follow calculation of a complex number field, not to precede calculation of the complex number field, a correlation of a hologram may be further enhanced.

According to the embodiment, the holographic image processing apparatus may modify a pixel pitch of an area with a different wavelength among the acquired holographic images to encode the holographic image.

A holographic image changes depending on a wavelength and thus has no correlations between RGB channels. However, when the holographic image display apparatus represents holographic images with different pixel pitches for the RGB channels, correlations between the RGB channels may be enhanced. The holographic image processing apparatus may modify a pixel pitch of an area with a different wavelength to enhance correlations of a hologram between channels. In addition, the holographic image processing apparatus may apply the same random phase to all channels in view of a random phase.

The holographic image processing apparatus may encode the holographic image based on the received wavelength information and the pixel pitch information.

In encoding the holographic image, a wavelength and a pixel pitch with respect to a light source of the holographic image display apparatus may be considered, because a wavelength and a pixel pitch which are unsuitable for the holographic image display apparatus causes representation of a distorted holographic image. Further, the holographic image processing apparatus may calibrate a wavelength difference and a pixel pitch difference using a transcoding technique for a holographic image. Accordingly, the holographic image processing apparatus may standardize a representative hologram format with respect to representative wavelengths for the respective RGB channels and various pixel pitches.

For example, the holographic image processing apparatus may define RGB wavelengths as 660 nm, 532 nm, and 450 nm and allow the holographic image display apparatus to use only a light source in a possible transcoding range at a corresponding wavelength. A pixel pitch varies depending on an advancement level of technology and thus is difficult to standardize. However, when the holographic image processing apparatus groups possible mutual transcoding ranges in a single category for management, holographic image display apparatuses may be divided by type.

That is, the holographic image processing apparatus groups holographic image display apparatuses using light sources with various wavelength ranges and pixel pitches according to possible mutual transcoding range value the holographic image display apparatuses by type. Accordingly, the holographic image processing apparatus may easily provide holographic image services. Here, transcoding may include not only a process of calibrating a pixel pitch and wavelength of a holographic image but also a process of converting a holographic image into a two-dimensional (2D)/three-dimensional (3D) image.

In operation 204, the holographic image processing apparatus may generate the encoded holographic image.

In addition, the holographic image processing apparatus may transmit the generated holographic image to the holographic image display apparatus.

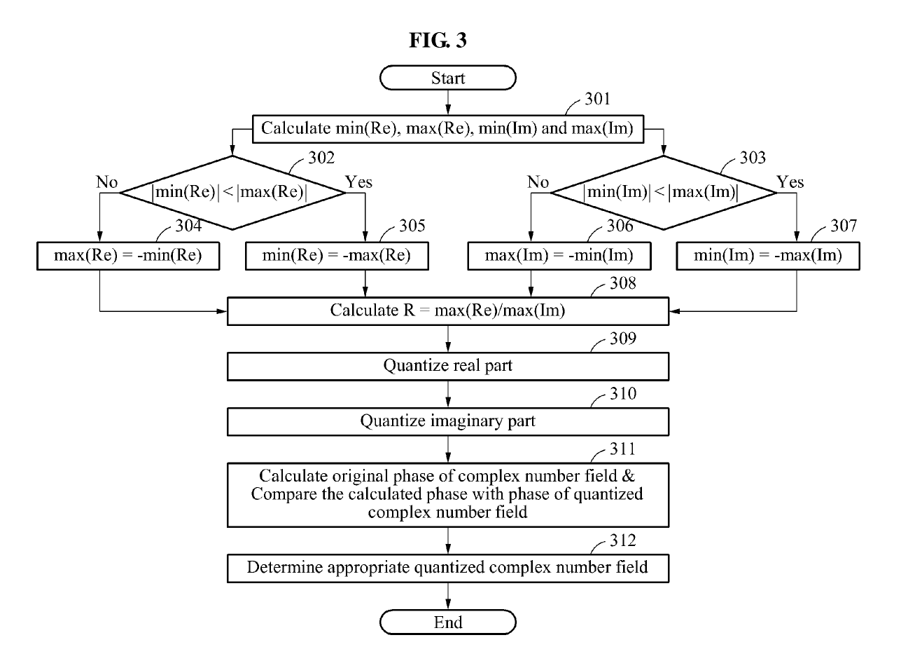

FIG. 3 is a flowchart illustrating a holographic image processing method according to an embodiment.

The holographic image processing method is a technique of expressing a real part (Re) and an imaginary part (Im) of a complex number field of a holographic image as image forms, respectively, maintaining temporal correlations. The real part and the imaginary part of the complex number field have independent ranges of values.

FIG. 3 shows a quantization operation for compression and digital imaging of a holographic image using a complex number field.

A holographic image processing apparatus may calculate minimum values (min values) and maximum values (max values) of a real part and an imaginary part in operation 301, compare absolute values of the min values with absolute values of the max values in operations 302 and 303, and redefine the min values and the max values based on larger absolute values in operations 304, 305, 306, and 307. Here, the min values and the max values have the same values but different signs.

In operation 308, the holographic image processing apparatus calculates a ratio of the real part to the imaginary part using the max values of the real part and the imaginary part. In operations 309 and 310, the holographic image processing apparatus quantizes the real part and the imaginary part. Operations 309 and 310 may be performed simultaneously, or operation 309 may follow operation 310 if necessary. That is, the holographic image processing apparatus may perform quantization of the real part and quantization of the imaginary part in reverse order or simultaneously perform quantization of the real part and quantization of the imaginary part. The quantized real part and imaginary part may need to maintain original phase values of the complex number field before quantization if possible. The quantization order of the real part and the imaginary part may change. The holographic image processing apparatus may need to consider a sign when phases of the quantized values are calculated. Original values of the complex number field before quantization range from a negative value to a positive value. However, since the quantized values are positive, the holographic image processing apparatus divides the quantized values into positive and negative values based on a median value and calculates the phases of the quantized values.

Thus, the holographic image processing apparatus needs to verify whether the real part and the imaginary part maintain the original phase values in operation 311, because the values of the real part and the imaginary part are lost during quantization.

For example, the holographic image processing apparatus may assume that (real part, imaginary part) is represented by (20, 10) through quantization. Further, the holographic image processing apparatus does not know which pixel combination among (20, 10), (19, 10), (21, 10), (20, 9), and (20, 11) is further appropriate for an original phase of a complex number in view of loss during quantization. Thus, the holographic image processing apparatus selects a pixel combination having the most similar phase values to the original phase values of the complex number field during quantization in operation 312. Also, although five pixel combination candidates are illustrated, the holographic image processing apparatus possibly expands pixel combination candidates to regions with adjacent values, (21, 11) and (19, 9).

For a plurality of frames, the holographic image processing apparatus may conduct quantization based on a quantized value of a previous or subsequent frame or an original value of a complex field in order to improve a temporal correlation.

A real part and an imaginary part of a complex number field generally have a Gaussian form, and thus non-uniform quantization may be more useful. When non-uniform quantization is used, the holographic image processing apparatus may express a shallower-depth plane. The holographic image display apparatus may display a higher quality than when the same-depth plane is used. Accordingly, output from the holographic image display apparatus may need to follow characteristics of non-uniform quantization, and additional information on which reference value is used depending on a quantization method to achieve quantization and on how a bit plane is changed if the bit plane is changed by non-uniform quantization may be defined and transmitted.

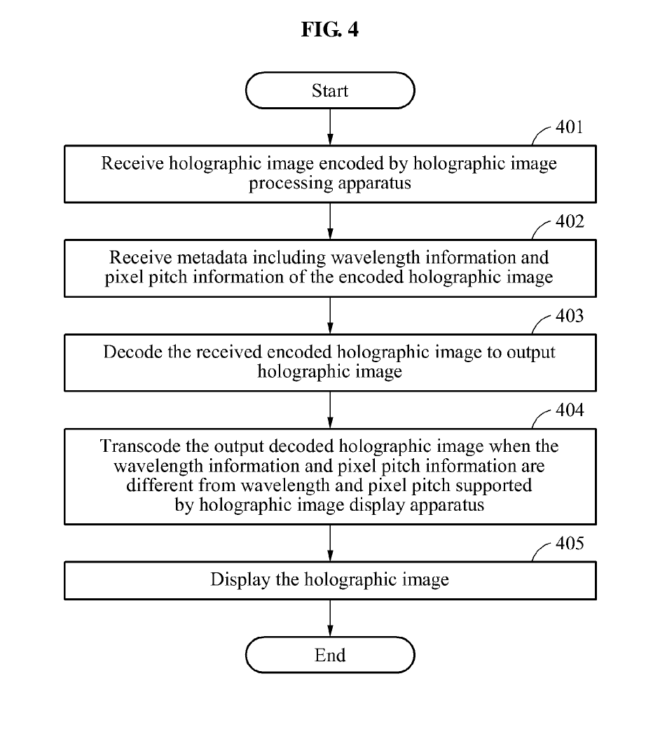

FIG. 4 is a flowchart illustrating a holographic image display method performed by a holographic image display apparatus according to an embodiment.

Referring to FIG. 4, the holographic image display method performed by the holographic image display apparatus is carried out as follows.

In operation 401, the holographic image display apparatus may receive a holographic image encoded by a holographic image processing apparatus.

Here, the encoded holographic image may be generated by quantizing a holographic image to improve at least one of a temporal correlation, a spatial correlation, and a channel correlation. Further, the encoded holographic image may be obtained by quantizing a holographic image acquired using a ratio based on absolute values of maximum values or minimum values of a real part and an imaginary part of a complex number field of a holographic image acquired by the holographic image processing apparatus.

In operation 402, the holographic image display apparatus may receive metadata including wavelength information and pixel pitch information of the encoded holographic image. When the holographic image display apparatus does not receive the metadata in operation 402, the holographic image display apparatus may use standardized wavelength information and pixel pitch information. The metadata may include depth information of a reproducible area in addition to the wavelength information and the pixel pitch information.

In operation 403, the holographic image display apparatus may decode the received encoded holographic image to output the holographic image.

In operation 404, the holographic image display apparatus may transcode the output decoded holographic image when the wavelength information and the pixel pitch information of the encoded holographic image are different from a wavelength and a pixel pitch supported by the holographic image display apparatus.

In operation 405, the holographic image display apparatus may display the output holographic image. The holographic image display apparatus may also display the transcoded holographic image. Here, as necessary, the holographic image display apparatus may display a 2D or 3D image in addition to the holographic image.

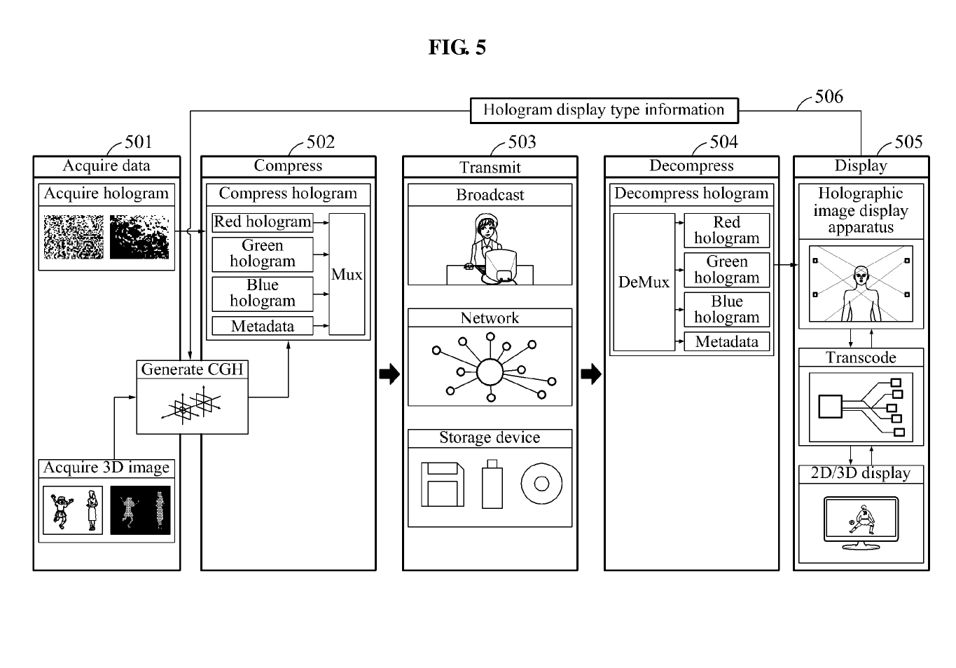

FIG. 5 illustrates a holographic image processing method and a holographic image display method according to an embodiment.

FIG. 5 shows a holographic video system in a case where a wavelength and a pixel pitch are standardized. A hologram may be acquired directly or generated by computer-generated holography (CGH).

A holographic image display apparatus that is a hologram display 505 may transmit hologram display type information in operation 506. The hologram display type information may include category information of a wavelength and a pixel pitch, described above, and wavelength and pixel pitch values. The holographic image display apparatus may have a function of displaying a 2D or 3D image. The holographic image display apparatus may also be a 2D or 3D image display apparatus.

A holographic image processing apparatus (not shown) may transmit a hologram generated by compressing a hologram into the same display type as that for the holographic image display apparatus. Metadata of the transmitted hologram may include depth information of a reproducible area and wavelength and pixel pitch information of the hologram.

The holographic image display apparatus may verify the received wavelength and pixel pitch information of the hologram, and represent the hologram as it is when the received wavelength and pixel pitch information is the same as information on the holographic image display apparatus. Even though the received wavelength and pixel pitch information is different from the information on the holographic image display apparatus, the hologram belong to the same category, making it possible that the holographic image display apparatus converts and represents the hologram by transcoding. A hologram transcoder may be disposed in the holographic image display apparatus or be provided as a separate external device connected to the holographic image display apparatus. The transcoder may include a channel configured to exchange information with the holographic image display apparatus. As necessary, transcoding may include not only a process of converting a holographic image depending on a pixel pitch and a wavelength but also a process of converting a holographic image into a 2D or 3D image. Here, an image having subjected to transcoding may be 2D- or 3D-displayed and reproduced as a 2D or 3D image.

If necessary, the holographic image processing apparatus may include a backchannel configured to provide information on a display environment to the holographic image display apparatus.

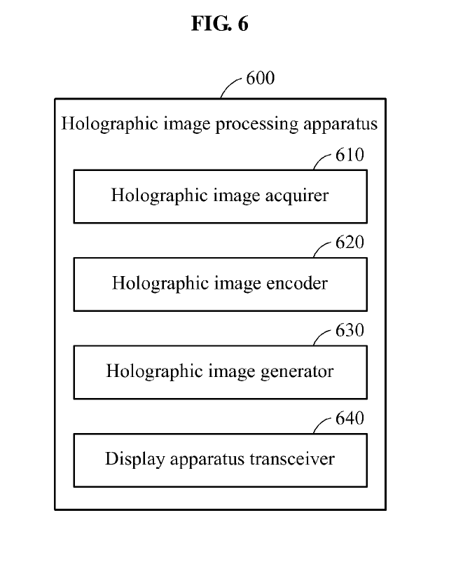

FIG. 6 is a block diagram illustrating a holographic image processing apparatus 600 according to an embodiment.

Referring to FIG. 6, the holographic image processing apparatus 600 may include a holographic image acquirer 610, a holographic image encoder 620, a holographic image generator 630, and a display apparatus transceiver 640. The holographic image processing apparatus may be a server or computing device, without being limited thereto.

The holographic image acquirer 610, the holographic image encoder 620, the holographic image generator 630, and the display apparatus transceiver 640 may be configured to include at least one of a processor, a memory, and a data transceiver.

The holographic image acquirer 610 may acquire a holographic image. The holographic image acquirer 610 may transmit the acquired holographic image to the holographic image encoder 620.

The holographic image encoder 620 may quantize the acquired holographic image in order to improve at least one of a temporal correlation, a spatial correlation, and a channel correlation of the holographic image, thereby encoding the holographic image.

The holographic image encoder 620 may quantize the acquired holographic image using a ratio based on absolute values of maximum values or minimum values of a real part and an imaginary part of a complex number field of the holographic image.

The holographic image encoder 620 may derive a ratio based on absolute values of maximum values or minimum values of a real part and an imaginary part of a complex number field using a texture image and a depth image among the acquired holographic images to quantize the holographic image. Here, the texture image has a fixed pixel value and the random image has a random pixel value.

For successive holographic images among the acquired holographic images, the holographic image encoder 620 may generate a random pattern to encode the holographic images. Here, the holographic image encoder 620 may encode the holographic images by using the same random pattern or a modified random pattern generated by modifying the same random pattern for adjacent areas of the holographic images.

The holographic image encoder 620 may encode the holographic image by modifying a pixel pitch of an area having a different wavelength among the acquired holographic images.

The holographic image generator 630 may generate the encoded holographic image.

The display apparatus transceiver 640 may transmit the generated holographic image to a holographic image display apparatus configured to display a holographic image.

The display apparatus transceiver 640 may receive wavelength information and pixel pitch information of the holographic image display apparatus from the holographic image display apparatus. Here, the holographic image encoder 620 may encode the holographic image based on the received wavelength information and pixel pitch information.

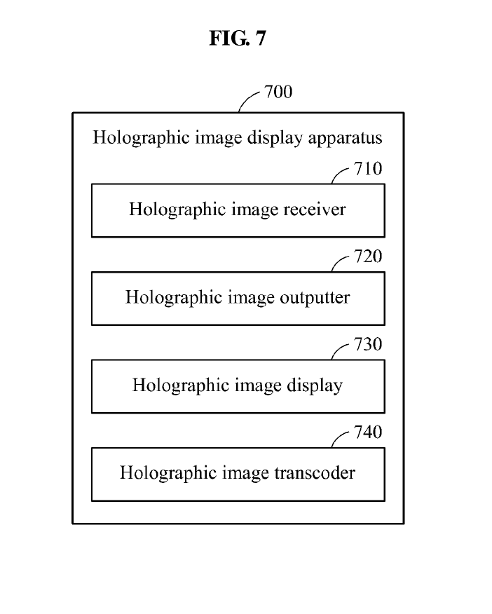

FIG. 7 is a block diagram illustrating a holographic image display apparatus 700 according to an embodiment.

Referring to FIG. 7, the holographic image display apparatus 700 may include a holographic image receiver 710, a holographic image outputter 720, a holographic image display 730, and a holographic image transcoder 740. The holographic image display apparatus 700 may be a hologram television or a hologram stereoscopic image device, without being limited thereto. As necessary, the holographic image display apparatus 700 may also have a 2D or 3D image display function. Also, the holographic image display apparatus 700 may be a 2D or 3D image display apparatus.

The holographic image receiver 710, the holographic image outputter 720, the holographic image display 730, and the holographic image transcoder 740 may be configured to include at least one of a memory, a processor, a data transceiver, an image signal processor, and an optical signal processor, without being limited thereto.

The holographic image receiver 710 may receive a holographic image encoded by a holographic image processing apparatus. Here, the encoded holographic image may be generated by quantizing a holographic image in order to improve at least one of a temporal correlation, a spatial correlation, and a channel correlation. Alternatively, the encoded holographic image may be a holographic image encoded by quantizing a holographic image acquired using a ratio based on absolute values of maximum values or minimum values of a real part and an imaginary part of a complex number field of the holographic image acquired by the holographic image processing apparatus.

The holographic image receiver 710 may receive metadata including wavelength information and pixel pitch information of the encoded holographic image or information on a hologram reproducible depth area.

The holographic image outputter 720 may decode the received encoded holographic image to output the holographic image.

The holographic image display 730 may display the output holographic image.

The holographic image transcoder 740 may transcode the output decoded holographic image when the wavelength information and the pixel pitch information of the encoded holographic image are different from a wavelength and a pixel pitch supported by the holographic image display apparatus. As necessary, the holographic image transcoder 740 may also convert a holographic image into a 2D or 3D image in addition to conducting a holographic image according to a pixel pitch and wavelength in transcoding.

Here, the holographic image display 730 may display the transcoded holographic image.

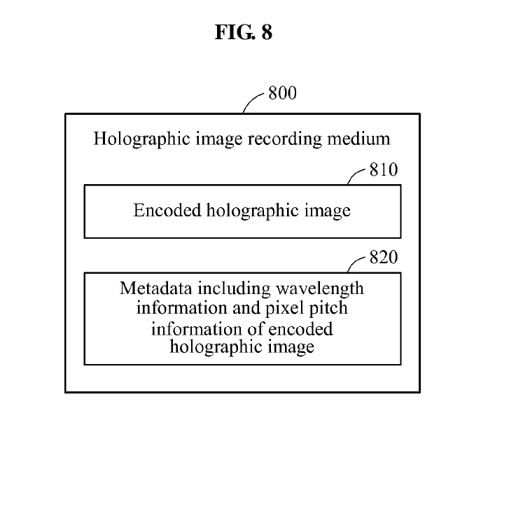

FIG. 8 is a block diagram illustrating a holographic image recording medium as a computer-readable recording medium according to an embodiment.

Referring to FIG. 8, the holographic image recording medium 800 includes an encoded holographic image 810 and metadata 820.

The encoded holographic image 810 may be a holographic image encoded by a holographic image processing apparatus.

Here, the encoded holographic image may be generated by quantizing a holographic image acquired by a holographic image processing apparatus in order to improve at least one of a temporal correlation, a spatial correlation, and a channel correlation.

The metadata 820 may include wavelength information and pixel pitch information of the encoded holographic image. Further, the metadata 820 may also include information on a hologram reproducible depth area.

According to embodiments of the present invention, high-efficiency hologram compression may be achieved. Accordingly, an effect of providing a high-quality holographic image with a smaller number of bits may be provided.

According to embodiments of the present invention, a holographic data format may to be defined. Accordingly, a holographic video system based on the holographic data format may be provided.

The units described herein may be implemented using hardware components, software components, or a combination thereof. The units and components may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-to transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits are combined or coupled in different forms and modes than as described above or be substituted or switched with other components or equivalents. Thus, other implementations, alternative embodiments and equivalents to the claimed subject matter are construed as being within the appended claims.

1. A holographic image processing method performed by a holographic image processing apparatus, the holographic image processing method comprising:
acquiring a holographic image;
encoding the holographic image by quantizing the holographic image to improve at least one of a temporal correlation, a spatial correlation, and a channel correlation of the acquired holographic image; and
generating the encoded holographic image.

2. The holographic image processing method of claim 1, wherein the encoding of the holographic image encodes the holographic image by quantizing the holographic image using a ratio based on absolute values of maximum values or minimum values of a real part and an imaginary part of a complex number field of the acquired holographic image.

3. The holographic image processing method of claim 1, wherein the encoding of the holographic image encodes the holographic image by deriving a ratio based on absolute values of maximum values or minimum values of a real part and an imaginary part of a complex number field using a texture image and a depth image among the acquired holographic images and quantizing the holographic image, the texture image has a fixed pixel value, and the depth image has a random pixel value.

4. The holographic image processing method of claim 1, wherein the encoding of the holographic image encodes the holographic image by generating a random pattern for successive holographic images among the acquired holographic images, and encodes the holographic image by using the same random pattern as the random pattern or a modified random pattern generated by modifying the same random pattern for adjacent areas of the holographic images.

5. The holographic image processing method of claim 1, wherein the encoding of the holographic image encodes the holographic image by modifying a pixel pitch of an area with a different wavelength among the acquired holographic images.

6. The holographic image processing method of claim 1, further comprising:
receiving wavelength information and pixel pitch information of a holographic image display apparatus configured to display the encoded holographic image from the holographic image display apparatus,
wherein the encoding of the holographic image encodes the holographic image based on the received wavelength information and pixel pitch information.

7. A holographic image display method performed by a holographic image display apparatus, the holographic image display method comprising:
receiving a holographic image encoded by a holographic image processing apparatus;
outputting the holographic image by decoding the received encoded holographic image; and
displaying the output holographic image,
wherein the encoded holographic image is generated by quantizing a holographic image to improve at least one of a temporal correlation, a spatial correlation, and a channel correlation.

8. The holographic image display method of claim 7, further comprising:
receiving metadata comprising wavelength information and pixel pitch information of the encoded holographic image or information on a hologram reproducible depth area; and
transcoding the output decoded holographic image when the wavelength information and the pixel pitch information of the encoded holographic image are different from a wavelength and a pixel pitch supported by the holographic image display apparatus,
wherein the displaying of the holographic image comprises displaying the transcoded holographic image, and the transcoded holographic image comprises a two-dimensional (2D) or three-dimensional (3D) converted holographic image.

9. The holographic image display method of claim 7, wherein the encoded holographic image is a holographic image encoded by quantizing a holographic image acquired by the holographic image processing apparatus using a ratio based on absolute values of maximum values or minimum values of a real part and an imaginary part of a complex number field of the acquired holographic image.

10. A holographic image processing apparatus comprising:
a holographic image acquirer to acquire a holographic image;
a holographic image encoder to encode the holographic image by quantizing the holographic image to improve at least one of a temporal correlation, a spatial correlation, and a channel correlation of the acquired holographic image; and
a holographic image generator to generate the encoded holographic image.

11. The holographic image processing apparatus of claim 10, wherein the holographic image encoder quantizes the holographic image using a ratio based on absolute values of maximum values or minimum values of a real part and an imaginary part of a complex number field of the acquired holographic image.

12. The holographic image processing apparatus of claim 10, wherein the holographic image encoder quantizes the holographic image by deriving a ratio based on absolute values of maximum values or minimum values of a real part and an imaginary part of a complex number field using a texture image and a depth image among the acquired holographic images, the texture image has a fixed pixel value, and the depth image has a random pixel value.

13. The holographic image processing apparatus of claim 10, wherein the holographic image encoder encodes the holographic image by generating a random pattern for successive holographic images among the acquired holographic images, and encodes the holographic image by using the same random pattern as the random pattern or a modified random pattern generated by modifying the same random pattern for adjacent areas of the holographic images.

14. The holographic image processing apparatus of claim 10, wherein the holographic image encoder encodes the holographic image by modifying a pixel pitch of an area with a different wavelength among the acquired holographic images.

15. The holographic image processing apparatus of claim 10, further comprising:
a display apparatus transceiver to transmit the generated holographic image to a holographic image display apparatus configured to display a holographic image.

16. The holographic image processing apparatus of claim 15, wherein the display apparatus transceiver receives wavelength information and pixel pitch information of the holographic image display apparatus from the holographic image display apparatus,
wherein the holographic image encoder encodes the holographic image based on the received wavelength information and pixel pitch information.

17-20. (canceled)
